(19) United States
(12) Patent Application Publication
(10) Pub. No.: US 2009/0058581 A1
(43) Pub. Date: Mar. 5, 2009

(54) COMPACT LINEAR ACTUATOR AND METHOD OF MAKING SAME

(76) Inventors: Edward A. NEFF, Cardiff By The Sea, CA (US); Toan Vu, San Diego, CA (US); Karl Stocks, Oceanside, CA (US); Naoyuki Okada, San Diego, CA (US); Andrew Gladoch, San Marcos, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/184,918

(22) Filed: Aug. 1, 2008

Related U.S. Application Data
(60) Provisional application No. 60/953,442, filed on Aug. 1, 2007.

(51) Int. Cl. H01F 7/06; H02K 7/06

(52) U.S. Cl. 335/228; 310/20

(57) ABSTRACT

This invention describes a compact linear moving coil actuator that incorporates a piston bobbin coil assembly that provides a shaft with linear reciprocal movement. Optionally, a rotary motor can be coupled to the shaft to provide rotary reciprocal movement. The piston and bobbin sections of the piston bobbin coil assembly may be integrally formed as a single unitary piece and easily changed in size and/or configuration during manufacture to enable easier and more cost-effective assembly of various actuator sizes and configurations. Additionally, the compact size of the actuator requires less work space and also allows multiple actuators to be positioned next to each for various applications.

### PRIORITY INFORMATION

This application claims priority under 35 U.S.C. § 119(e) to U.S. provisional patent application No. 60/953,442 filed on Aug. 1, 2007, the content of which is incorporated by reference herein in its entirety.

### FIELD OF THE INVENTION

The invention relates to moving coil actuators and, more particularly, to a compact linear actuator and method of making same.

### BACKGROUND OF THE INVENTION

It is known that moving coil actuators can be used to impart a particular force against an object at one or more desired locations on the object. In many applications, it is desirable to accurately and precisely control the magnitude, timing and location of the force imparted onto the object (a.k.a., work piece).

Manufacturing actuators capable of precise and accurate movement, however, can be costly and time-consuming. In addition, conventional actuators can take a significant amount of workspace to perform their intended function. Furthermore, it can be costly and time-consuming to modify the design of conventional linear actuators during the manufacturing process to accommodate different application requirements.

In light of the above, there is a need to provide an actuator that can be manufactured and assembled quickly and cost effectively. Another need is to provide an actuator that is relatively small, lightweight, and compact. A further need is to provide a flexible design that is easily reconfigurable during manufacturing so that various actuator configurations can be produced to conform to the specifications of a particular project.

### SUMMARY OF THE INVENTION

The invention addresses the above and other needs by providing a novel compact linear moving-coil actuator and method of manufacturing same.

In accordance with one embodiment, a linear actuator includes a generally cylindrically-shaped housing and a piston bobbin coil assembly positioned inside the housing and slidably coupled to a guide rail also contained within the housing. A shaft or probe capable of linear reciprocal movement is attached to an end of the piston opposite the bobbin and coil, and extends at least partially through an opening in the housing. A bobbin section of the piston bobbin coil includes a longitudinal channel extending through the bobbin section. A central pole is slidably positioned in the longitudinal channel.

In one embodiment, a linear actuator includes a piston bobbin coil assembly wherein the piston and bobbin sections of the assembly are formed as a single integral piece by extrusion.

In a further embodiment, the piston bobbin coil assembly can be formed with one or more bobbin sections to accommodate one or more coils wound around each respective bobbin section. For example, the piston bobbin coil assembly can comprise two or three bobbin and coil sections.

In yet another embodiment, the linear actuator can include a rotary motor coupled to the piston and to a shaft for providing rotational reciprocal movement to the shaft.

### BRIEF DESCRIPTION OF THE DRAWINGS

FIG. 1 illustrates a linear moving coil actuator according to an exemplary embodiment of the present invention.

FIG. 2 is a cross-sectional view of the linear actuator of FIG. 1 according to an exemplary embodiment of the present invention.

FIG. 3 is a perspective view of a base of a linear actuator according to an exemplary embodiment of the present invention.

FIG. 4 is a top view of a piston bobbin coil according to an exemplary embodiment of the present invention.

FIG. 5 is a cross-sectional view of the piston bobbin coil (viewed from the bobbin section end) of FIG. 4 according to an exemplary embodiment of the present invention.

FIG. 6 is a perspective view of the piston bobbin coil of FIG. 4 attached to the base of FIG. 3 according to an exemplary embodiment of the present invention.

FIG. 7 is a front view of a center pole attached to an end plate according to an exemplary embodiment of the present invention.

FIG. 8 is at top view of the center pole attached to the end plate of FIG. 7 according to an exemplary embodiment of the present invention.

FIG. 9 is a bottom view of a housing of an actuator according to an exemplary embodiment of the present invention.

FIG. 10 is a bottom view of the housing of FIG. 9 with the center pole of FIGS. 7 and 8 positioned inside the housing according to an exemplary embodiment of the present invention.

FIG. 11 is a side view of the actuator with the housing partially cut away according to an exemplary embodiment of the present invention.

FIG. 12 is a front perspective view of the actuator according to an exemplary embodiment of the present invention.

FIG. 13 is a back perspective view of the actuator according to an exemplary embodiment of the present invention.

FIG. 14 is a cross-sectional view of an actuator having a double coil configuration according to an exemplary embodiment of the present invention.

FIG. 15 is a perspective view of a piston bobbin coil assembly having three bobbin and coil sections according to an exemplary embodiment of the present invention.

### DETAILED DESCRIPTION OF EXEMPLARY EMBODIMENTS OF THE INVENTION

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

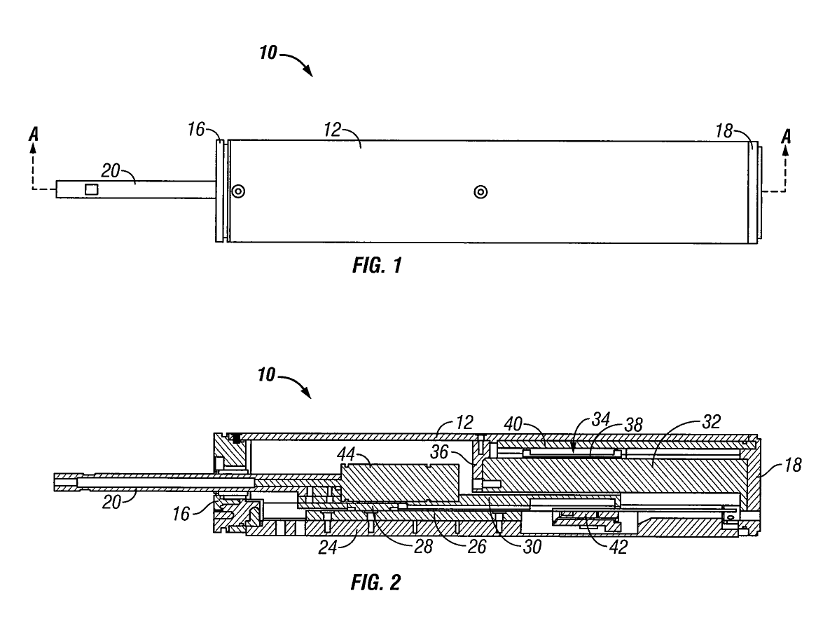

FIG. 1 is a top view of an actuator 10 according to an exemplary embodiment of the present invention. The actuator 10 includes a substantially cylindrically-shaped housing 12 with a front brushing retainer 16 attached to a front end of the housing 12 and an end plate 18 attached to a back end of the housing 12. A shaft 20 is positioned for linear and/or rotary reciprocal movement through an opening 22 (not shown in FIG. 1) in the front brushing retainer 16.

FIG. 2 is a cross-sectional side view of the actuator 10 across lines A-A shown in FIG. 1. The actuator 10 includes a base 24 attached to a bottom section of the housing 12. A linear guide rail 26 is mounted on the base 24 and a linear guide carriage 28 is slidably mounted on the linear guide rail 26 for linear reciprocal movement thereon. A piston bobbin coil assembly 30 is attached to the linear guide carriage 28 for movement with the linear guide carriage 28. In one embodiment, the shaft 20 can be attached directly to a piston section of the piston bobbin coil assembly 30 for linear reciprocal movement with the piston bobbin coil assembly 30 and the linear guide carriage 28. However, as discussed in further detail below, in an optional alternative embodiment, the shaft 20 (a.k.a., probe 20) is rotatably coupled to a rotary motor 44 that is attached to the piston section. The rotary motor 44 provides rotational reciprocal movement to the shaft 20, while the piston bobbin coil assembly 30 and linear guide carriage 28 provide linear reciprocal movement to the shaft 20.

A center pole 32 is positioned inside a central channel of a bobbin portion 34 of the piston bobbin coil assembly 30. The center pole 32 is held in place at one end by the end plate 18 and at the other end by a side plate 36. A coil 38 of the piston bobbin coil 30 is wound around the bobbin portion 34. In one embodiment, coil 38 comprises a copper wire having a desired gauge and length to provide a desired number of turns around the bobbin section 34. One or more magnets 40 are affixed to the interior of the housing 12. An electromotive force is supplied by the interaction between the magnets 40 and an electromagnetic field provided by an electric current through the coil portion 38. This electromotive force can provide linear reciprocal movement to the piston bobbin coil assembly 30, the shaft 20, and the guide carriage 28. In addition, a linear encoder feedback device 42 can be attached to the housing 12 to track the linear motion of the piston bobbin coil assembly 30 and, hence, the shaft 20.

With further reference to FIG. 2, a rotary motor 44 can be optionally included. The rotary motor 44 is mounted on the piston bobbin coil assembly 30 and functionally attached to the shaft 20. The rotary motor 44 can supply a rotary force to the shaft 20, causing the shaft 20 to rotate in desired directions and speeds. The rotary motor 44 can also include an encoder (not shown) for providing feedback related to rotational movement of the shaft 20. If the rotary motor 44 is omitted, then the actuator 10 can be shorter in length because it does not need to accommodate the rotary motor 44. Alternatively, if the rotary motor 44 is included, then the actuator 10 can be longer in length to accommodate the rotary motor 44.

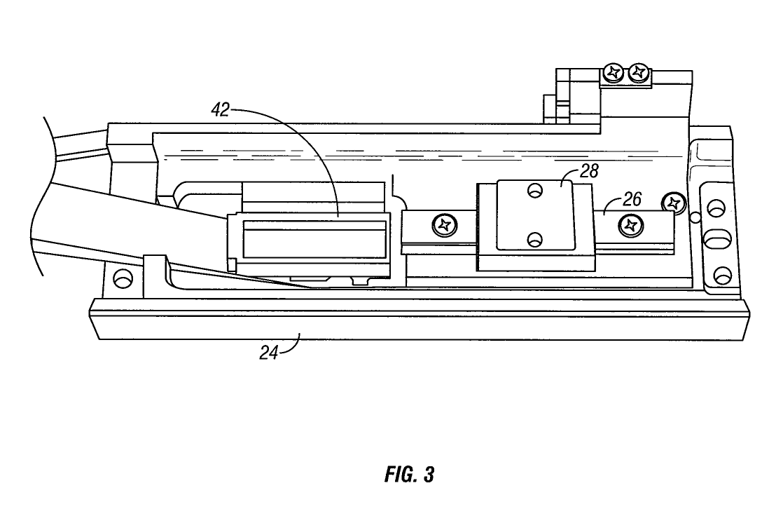

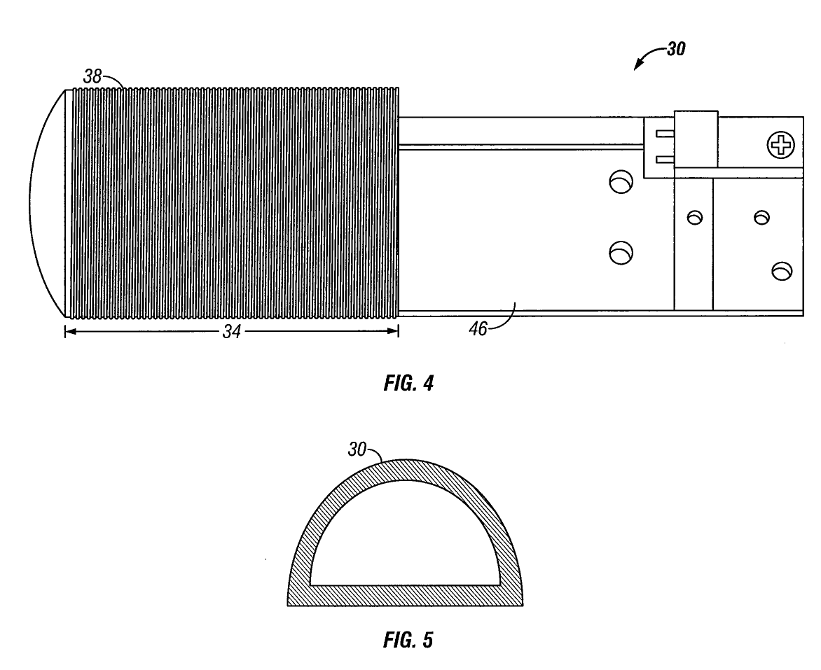

Further details regarding the actuator 10 will now be described with reference to FIGS. 3-13.

FIG. 3 illustrates the base 24 removed from the housing 12. Mounted on the base 24 are the linear guide rail 26 and the linear encoder 42. FIG. 3 also shows the linear guide carriage 28 slidably mounted on the linear guide rail 26 in order to allow the linear guide carriage 28 to move in a linear fashion.

Referring now to FIG. 4, the piston bobbin coil 30 is shown in more detail. In one embodiment, the piston bobbin coil 30 comprises three sections: the piston section 46, the bobbin section 34, and the coil section 38. The piston section 46 is mounted to the linear guide carriage 28 (shown in FIG. 2) and also carries the shaft 20 and optional rotary motor 44 (shown in FIG. 2). The bobbin section 34 can have a central channel (shown in FIG. 5) having a cross-sectional shape similar to that of the central pole 32 (e.g., semi-circular). The coil 38 is wound around the bobbin section 34. In accordance with various embodiments, the cross-sectional shape of the central channel and the central pole 32 are semicircular. In one embodiment, the coil 38 is a copper wire having a desired gauge and length to provide a desired number of turns around the bobbin section 34.

Furthermore, in accordance with various embodiments, the piston 46 and bobbin 34 sections of the piston bobbin coil assembly 30 can be formed as a single, unitary piece. For example, the piston and bobbin section can be formed as a single integral piece by extrusion and thereafter machined into a desired shape using a lathe, for example. Although the piston bobbin section need not be formed as a single, unitary piece, it has been found that a single, unitary piece can make construction of the actuator 10 less complicated and quicker to assemble because there are fewer pieces. Moreover, using a single unitary piece can be more cost effective, as a single piece can be less costly to manufacture than multiple separate pieces. A single, unitary piece can also weigh less than a multi-piece piston bobbin, as a multi-piece piston bobbin may require additional fasteners or hardware to attach the various pieces together.

The piston bobbin section can be made out of various materials, including various types of metals. In accordance with various exemplary embodiments, the piston bobbin section is made out of aluminum. Aluminum can be advantageous due to its beneficial heat transfer properties as well as due to its light weight as compared to many other types of metals.

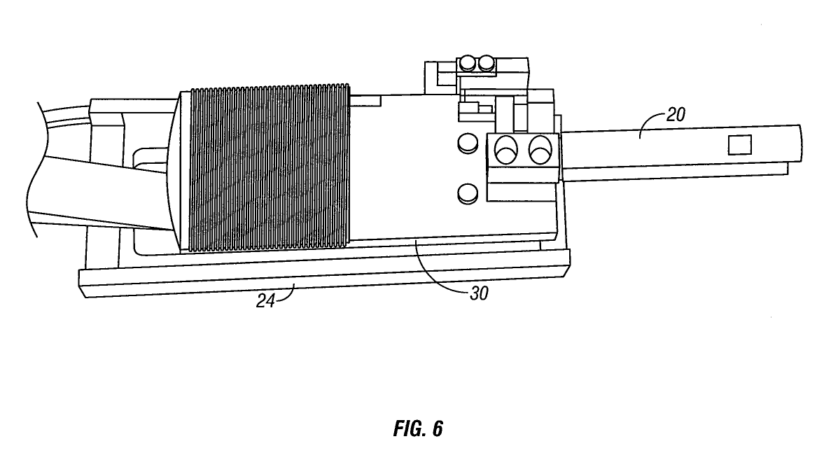

FIG. 6 shows the piston bobbin coil assembly 30 attached to the base 24. As described above with reference to FIG. 2, the piston bobbin coil assembly 30 is slidably attached to the base 24 via the linear guide carriage 28 (FIG. 3) and, in turn, the linear guide rail 26. FIG. 6 also shows the shaft 20 attached to the piston section 46 of the piston bobbin coil assembly 30.

A current applied to the coil 38 (shown in FIG. 4) provides a magnetic field that interacts with the magnetic field of the one or more magnets 40 (shown in FIG. 2). This interaction between the magnetic fields generates an electromotive force that propels the piston bobbin coil 30, the shaft 20, and the guide carriage 28 (shown in FIG. 2) along the guide rail 26 in a desired direction and speed dependant on the magnitude and polarity of the current through the coil 38.

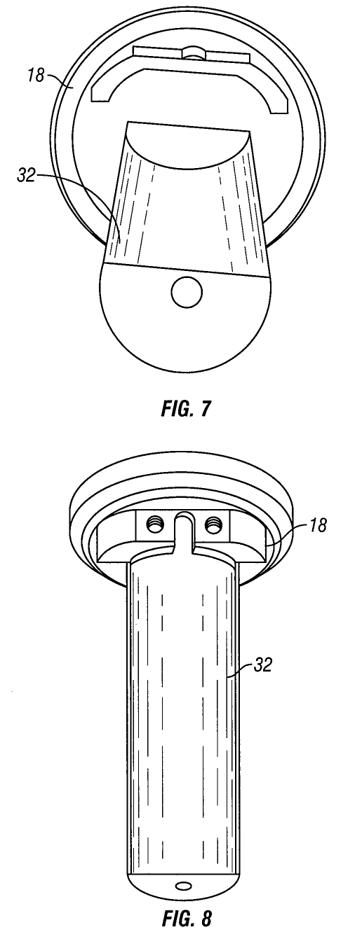

FIGS. 7 and 8 are respective front and top views of the center pole 32 attached to the end plate 18. In an exemplary embodiment, the center pole 32 can have a generally semicircular cross-sectional shape, so as to be slidably received within a correspondingly shaped channel of the bobbin section 34 (shown in FIG. 4). The center pole 32 helps guide and stabilize the piston bobbin coil assembly 30 when it is moving.

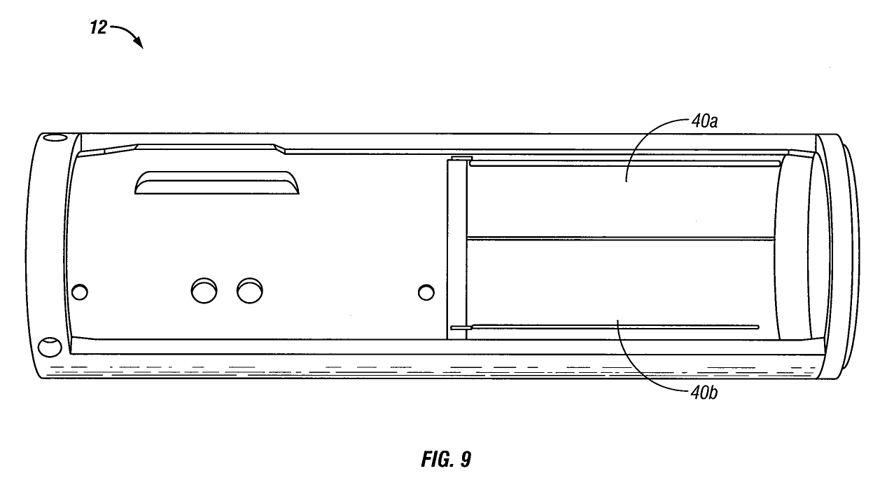

In addition, the end of the center pole 32 opposite of the end plate 18 is configured to be attached to the side plate 36, as shown in FIG. 2. The end plate 18 and side plate 36 are attached to the housing 12 (shown in FIG. 9).

FIG. 9 is a bottom view of the housing 12. Substantially the entire bottom section of the housing 12 comprises an opening designed to accept the base 24 (shown in FIG. 8). In addition, two magnet elements 40a and 40b are mounted on an interior wall of the housing 12. The end plate 18 (shown in FIG. 8) is attached to the end of housing 12 proximal to the magnets 40a and 40b. The side plate 36 (shown in FIG. 2) is attached to the interior of the housing 12 proximal to the magnets 40a and 40b but distal to the end plate 18 (shown in FIG. 8) end. The central pole 32 is attached between the end plate 18 (shown in FIG. 8) and the side plate 36 (shown in FIG. 2).

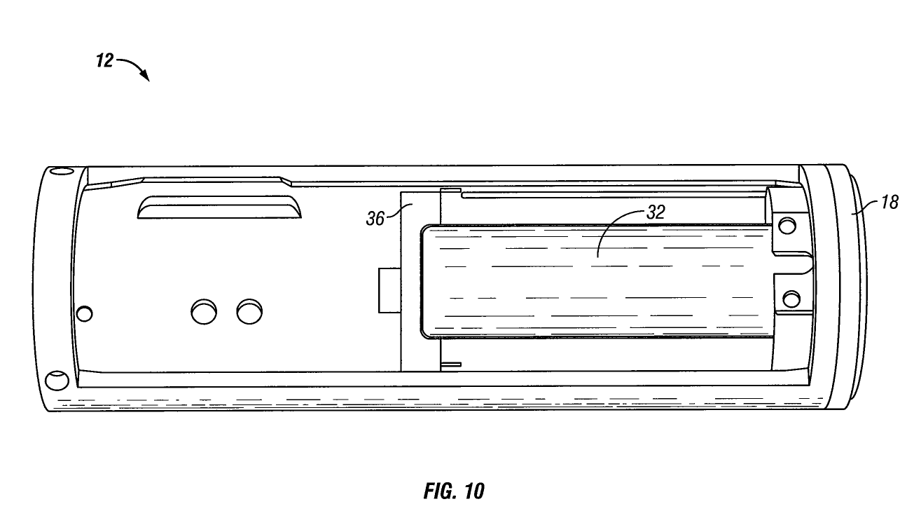

FIG. 10 shows the center pole 32 attached to the side plate 36 and the end plate 18. The center pole 32 is configured to travel within the correspondingly shaped longitudinal channel of the bobbin section 34 of the piston bobbin coil assembly 30 as discussed above.

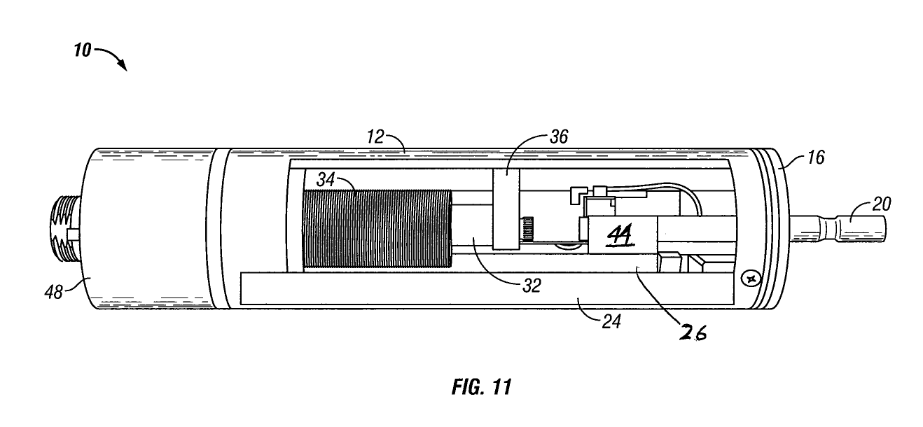

FIG. 11 is a partially broken away side view of the actuator 10 in an assembled configuration. As shown, the base 24 is attached to the housing 12. A guide rail 26 (FIG. 2) is attached to the base and a linear guide carriage 28 (FIG. 2) is slidably attached to the guide rail 26 to provide the guide rail with linear reciprocal movement. The piston bobbin coil 30 (FIG. 2) is attached on top of the guide rail 26 and a shaft 20 is attached to a rotary motor 44 the piston bobbin coil 30. FIG. 11 also shows the center pole 32 attached to the side plate 36 and slidably positioned inside the central channel of the bobbin portion 34 of the piston bobbin coil assembly 30.

The configuration in FIG. 11 allows for linear reciprocal movement of the shaft 20 through the front brushing retainer 16. This linear reciprocal movement is provided through an electromotive force through the interaction between two magnetic fields. The magnetic fields are provided by one or more magnets 40 (shown in FIG. 2) and by an electromagnetic field provided by current flowing through the coil portion 38 of the piston bobbin coil 30. The magnetic interaction forces the piston bobbin coil 30 to move linearly along the guide rail 26 and the center pole 32. The direction of movement is dependant upon the direction of current through the coil 38.

A mount/connector cover 48 is also shown attached to the back end of the actuator 10 in FIG. 11. The mount/connector cover can be adapted to quickly and conveniently attach the actuator 10 to a connector of a controller (not shown). Such a controller can be configured to control the movement of the actuator 10 by selectively applying current to the actuator 10. The controller can also receive and process signals provided by the linear encoder 42 and rotary encoder (not shown), for example.

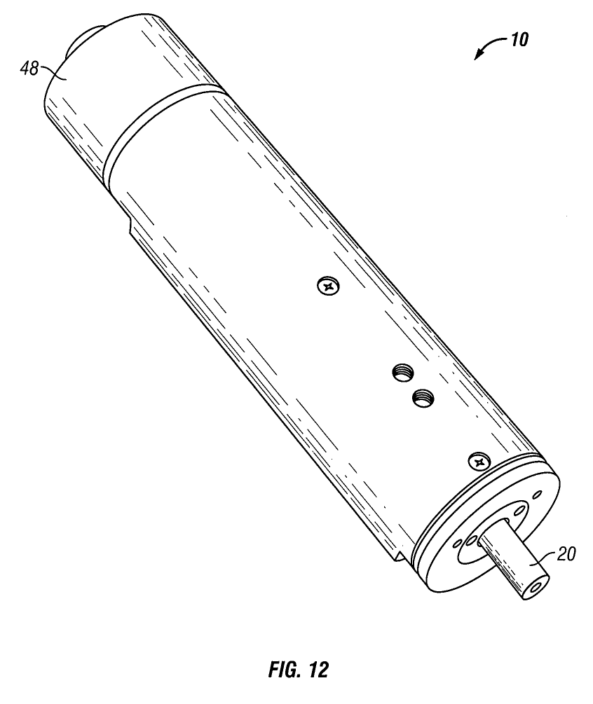

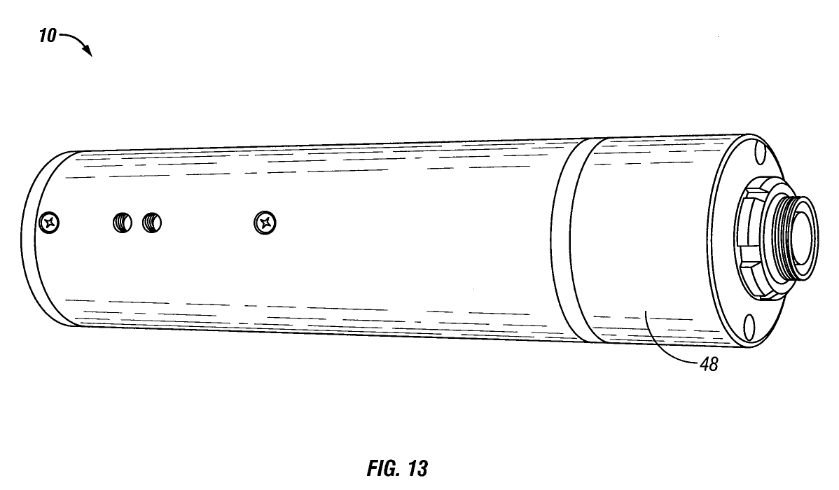

FIGS. 12 and 13 show perspective front and back views, respectively, of the actuator 10 in its assembled configuration. As can be seen, the actuator 10 has a generally cylindrical shape and is relatively compact in size. A compact size can allow, for example, multiple actuators to function side-by-side occupying less overall space than conventional actuators.

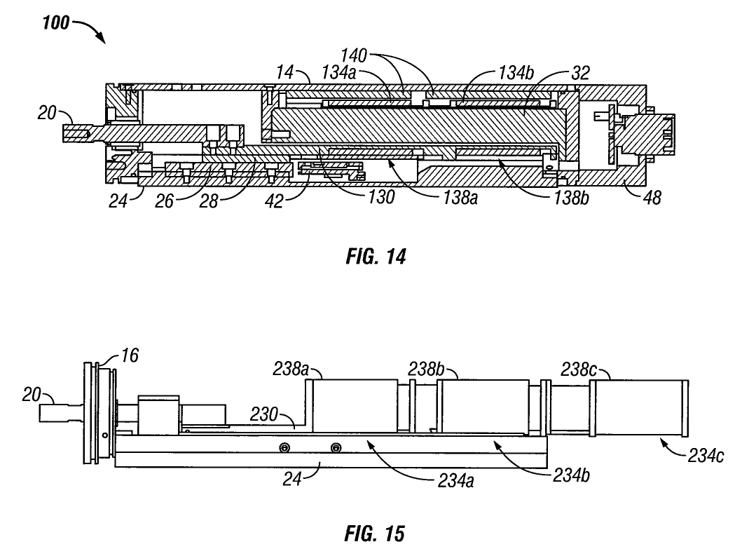

FIG. 14 is a cross-sectional view of a double-coil linear actuator 100 according to an exemplary embodiment. Some components of the actuator 100 are similar to the actuator 10 as shown in FIG. 2. Similar to the actuator 10, the actuator 100 includes a piston bobbin coil 130. However, the piston bobbin coil 130 includes first and second bobbin sections 134a, 134b and first and second coil sections 138a, 138b. To accommodate the additional bobbin and coil sections, various components of the actuator 100 can have a longer length than the similar components of actuator 10, such as the center pole 32, and the housing 14. Also, an additional row of magnets 140 are attached to the housing 14 to accommodate for the additional bobbin 134 and coil sections 138.

In accordance with various embodiments, the piston and dual bobbin sections of the piston bobbin coil assembly 130 may be formed as a single integral piece, similar to the piston bobbin section of the piston bobbin coil 30. In one embodiment, the piston and double bobbin section can be formed through an extrusion and machining process. In this regard, the design and manufacture of linear actuators in accordance with various embodiments can be flexible, since changing from one configuration to another does not require significant tooling or equipment changes. If a design calls for a double bobbin coil configuration, as shown in FIG. 14, then one additional bobbin coil section is formed and a few of the components of the linear actuator are lengthened to accommodate for the additional bobbin coil section. This can be done relatively easily by slightly modifying the extrusion and machining process.

Similar to the actuator 10, the actuator 100 can also optionally include a rotary motor (not shown) for providing rotational movement of the shaft 20 as well as a rotary encoder for providing feedback to a controller.

Furthermore, embodiments of actuators of the present invention need not be limited to one or two bobbin coil sections. Instead, any number of bobbin and coil sections can be used. For example, FIG. 15 is a side view of an actuator 200, with the housing removed, having a three bobbin and coil configuration. Specifically, a piston bobbin coil assembly 230 of the actuator 200 includes three bobbin sections 234a, 234ba and 234c and three coil sections 238a, 238b and 238c.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments

What is claimed is:

1. An actuator comprising:
a housing;
a piston contained within the housing;
a shaft coupled to the piston operable to engage an object;
a bobbin connected to the piston;
a coil wound around the bobbin;
a magnetic element positioned adjacent to the coil so as to generate a desired magnetic force with respect to the coil when a current is caused to pass through the coil, and wherein the piston and bobbin are integrally formed as a single piece.

2. The actuator of claim 1 further comprising a center pole contained within the housing wherein the bobbin comprises a longitudinal channel configured to slidably receive the center pole.

3. The actuator of claim 1 further comprising:
a base;
a guide rail supported by the base; and
a guide carriage slidably coupled to the guide rail, wherein the piston and bobbin are mounted onto the guide carriage.

4. The actuator of claim 1, further comprising a rotary motor mounted on the piston and coupled to the shaft to provide rotary reciprocal movement to the shaft.

5. The actuator of claim 4, further comprising a rotary encoder operable to track the rotational position of the shaft.

6. The actuator of claim 1, further comprising a linear encoder operable to track the linear position of the guide carriage.

7. The actuator of claim 1 wherein said piston and bobbin are formed as a single integral piece through extrusion.

8. The actuator of claim 1 wherein said piston and bobbin are formed as a single integral piece using a lathe to shape the single integral piece into the piston and bobbin.

9. The actuator of claim 1, further comprising at least one magnet attached to an interior of the housing adjacent to the coil.

10. The actuator of claim 1, further comprising a second bobbin and a second coil wound around the second bobbin.

11. An actuator comprising:
a bobbin;
a coil wound around the bobbin;
a piston coupled to the bobbin;
a linear carriage and rail for supporting and providing linear motion to the piston, bobbin and coil;
a rotary motor mounted on the piston; and
a shaft coupled to said rotary motor, said rotary motor operable to provide the shaft with rotary reciprocal movement.

12. The actuator of claim 11 wherein the piston and bobbin are integrally formed as a single piece.

13. The actuator of claim 11, further comprising a rotary encoder operable to track rotary reciprocal movement of the shaft.

14. The actuator of claim 11 further comprising:
a housing;
a base contained within the housing;
a guide rail supported by the base;
a guide carriage slidably coupled to the guide rail, where the piston is mounted on the guide carriage.

15. The actuator of claim 11, wherein the bobbin includes a longitudinal channel configured to slidably receive a center pole coupled to the housing.

16. The actuator of claim 11 further comprising a magnetic element affixed to an interior of the housing adjacent to the coil.

17. The actuator of claim 11, further comprising a linear encoder operable to track linear reciprocal movement of said piston bobbin coil.

18. The actuator of claim 11, further comprising a second bobbin and a second coil wound around the second bobbin.

19. The actuator of claim 11 wherein said piston and bobbin are integrally formed as a single piece through extrusion and machine shaping.

20. A method of manufacturing actuators capable of linear reciprocal movement, comprising:
mounting a base within a housing;
mounting a guide rail on the base;
slidably mounting a guide carriage on the guide rail operable to provide linear reciprocal movement to the guide carriage; and
mounting a piston bobbin coil assembly on the linear guide carriage, wherein a piston section and a bobbin section of the piston bobbin coil assembly are integrally formed as a single piece.

21. The method of claim 20, further comprising:
coupling a shaft to a rotary motor mounted on the piston, wherein the rotary motor is operable to provide the shaft with rotary reciprocal movement.

22. The method of manufacturing the actuator of claim 20, wherein the piston and bobbin sections are integrally formed through extrusion and machining into a desired shape.

23. The method of manufacturing the actuator of claim 20 further comprising mounting at least one magnet within an interior wall of the housing adjacent to the coil.
